(19) United States
(12) Patent Application Publication
(10) Pub. No.: US 2006/0284448 A1
(43) Pub. Date: Dec. 21, 2006

(54) Lorry

(75) Inventors: Harro Heilmann, Ostfildern (DE); Andreas Schwarzhaupt, Landau (DE); Gernot Spiegelberg, Heimsheim (DE); Wolfgang Stahl, Oberboihingen (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/545,423

(22) PCT Filed: Feb. 11, 2004
(86) PCT No.: PCT/EP04/01262

§ 371 Date: May 24, 2006

(30) Foreign Application Priority Data
Feb. 15, 2003 (DE) 103 06 368.4

(51) Int. Cl. B60J 7/00

(52) U.S. Cl. 296/190.04

(57) ABSTRACT

A truck has a chassis comprises a frame and axles, and a driver's cab mounted on the vehicle chassis. The cab comprises equipment components, a cab floor and also a cab housing and operating elements connected to associated components of the vehicle chassis and serving to operate them. The driver's cab is detachably fastened to the vehicle chassis, and is designed as a removable unit. An interface arrangement is provided, by which all the operating elements of the driver's cab are connected separably to the associated components of the vehicle chassis.

### BACKGROUND AND SUMMARY OF THE INVENTION

This application claims the priority of German patent document 103 06 368.4, filed Feb. 15, 2003 (PCT International Application No. PCT/EP2004/001262), the disclosure of which is expressly incorporated by reference herein.

The invention relates to a truck with a vehicle chassis comprising a frame and axles and with a driver's cab mounted on the vehicle chassis.

A truck of the generic type is known from German patent document DE 29 34 272 A1. The driver's cab is divided into two parts, namely a cab base, and a standardized cab upper part. The cab base is adapted to the chassis, and essentially comprises the driver's cab floor and all equipment components supported thereon (such as, for example, seats and steps) and also operating elements (such as, for example, light switches and pedals) for operating components on the chassis (such as, for example, lighting equipment, brake system and engine control). The standardized cab upper part essentially comprises a front wall, side walls with doors, a rear wall and a roof, and is fastened detachably on the cab base. By virtue of this arrangement, constructionally identical cab upper parts can always be used for chassis of very different kinds which result from different axle positions, different wheel sizes or other different functional purposes of the vehicle; that is one and the same cab upper part can be used for all truck models. Only the cab base, instead of the entire driver's cab as previously, needs to be adapted to the special embodiment concerned of the chassis.

A removable cab upper part for tractors which essentially has a roof, a front wall and a rear wall, and where the equipment components, such as for example a seat, pedals and a steering handle, are arranged in a stationary fashion on the vehicle, is disclosed in Japanese patent document JP 63162381 A.

German patent document DE 93 03 516 A discloses a track motor car which has a vehicle chassis comprising a frame and axles. A driver's cab, which comprises equipment components, a cab floor and also a cab housing and operating elements, is mounted tiltably on the vehicle chassis. The operating elements are connected to associated components of the vehicle chassis and serve to operate them. Furthermore, an interface arrangement formed by plug-type connections is provided, via which arrangement flexible lines below the cab floor can be connected to associated lines from the cab. In particular, operating elements of the driver's cab can in this way be connected separably to associated components of the vehicle chassis.

A hydraulic quick coupling, which can be used in particular as a hydraulic interface, disclosed in U.S. Pat. No. 5,316,347.

One object of the invention is to provide an improved driver's cab of a truck having enhanced maintenance-friendliness.

This and other objects and advantages are achieved according to the invention, by designing a driver's cab as a removable unit and fastening it detachably to a vehicle chassis.

To this end, an interface arrangement is provided, by which all the operating elements of the driver's cab are connected separably to the associated components of the vehicle chassis. In conventional trucks, the driver's cab may be of tiltable design for maintenance purposes. For more major work, such as for example engine removal, however, the driver's cab also has to be removed completely in many cases. The bearings necessary for tilting are complicated and expensive, and the structure of the driver's cab has to be designed for them. The mechanical connections usual nowadays for the operating elements (such as, for example, steering column, accelerator and brake pedals and also connecting lines) also have to be designed in such a way that tilting is readily possible.

For maintenance work which requires complete removal of the driver's cab, it is necessary to undo all the connections (mechanical, electrical etc.) between the vehicle chassis and the driver's cab, which is complicated and expensive in modern vehicles. To resolve this problem, according to the invention, the driver's cab can be raised for maintenance purposes, and all the operating elements of the driver's cab can at the interface arrangement be separated simply and rapidly from the associated components of the vehicle chassis. The enhanced maintainability of the vehicles in the field, improved handling in the workshop and the possibility of using lower workshop halls are of particular advantage.

According to the invention, the driver's cab, which is surrounded by a cab housing with a front wall, side walls with doors, a rear wall and a floor and comprises in its interior equipment components (such as for example seats, a dashboard, and also operating elements, such as switches, pedals etc.) is designed as a removable unit. This makes it possible to prefabricate the driver's cab as an independent unit and to arrange it on the vehicle chassis and connect it to it via the interface arrangement at the end of the production process. At the same time, the use of “steer by wire” and/or “brake by wire” controls, which is becoming increasingly common, is more readily attainable by virtue of the invention.

In the truck according to the invention, the vehicle chassis can be controlled by means of an external operating device (which may be a remote control) when the driver's cab has been removed. For more major maintenance work, for which the driver's cab has to be removed completely, the problem exists with conventional trucks that the vehicle chassis can be moved or controlled only with difficulty without the operating elements which are arranged in the driver's cab. To resolve this issue, the invention provides an external operating device, which in the best case is designed as a remote control, to be connected to at least one component of the vehicle chassis via the interface arrangement, and thus to operate functions, such as for example starting the engine, moving the vehicle forwards and backwards or switching a lighting device on and/or off. In this way, the mobility of the vehicle chassis, which previously could be moved only with difficulty without the driver's cab, or the operating elements installed therein, can be increased markedly. At the same time, it is possible to check or activate individual components of the vehicle chassis, such as for example engine, lighting device or the like, by virtue of which the maintenance-friendliness can be increased.

According to a particularly advantageous embodiment, the interface arrangement is formed by plug-type connections, which may be of standardized design. After the driver's cab has been raised, it is in this way readily possible to separate the operating elements of the driver's cab from the associated components of the vehicle chassis. In this respect, in particular plug-type connections designed as quick coupling means prove to be simple and quick to separate and join together again. The involved dismantling of mechanical connections and/or electric cabling previously necessary can be dispensed with, which saves time and costs. At the same time, it is possible by virtue of the standardized plug-type connections to connect different driver's cabs to different vehicle chassis, which increases flexibility in the assembly of driver's cab and vehicle chassis.

A particularly advantageous embodiment of the invention includes mobile and/or vehicle-mounted, extendable supports, by which the driver's cab can be raised in a manner similarly to a jack, so far that the vehicle chassis including the drive device can be driven away (alternatively of course pulled away as well, for example in the event of a defective drive device) below the driver's cab by means of the remote control. The resulting improved maintainability of the trucks in the field, improved handling in the workshop and also the autonomous operation of the trucks without the driver's cab are of particular advantage. The vehicle-mounted supports may also be integrated into the driver's cab, so that separation of driver's cab and vehicle chassis is also possible in the field, and the trucks can be repaired outside workshops. At the same time, with this variant embodiment, the vehicle supports which are normally required in the workshops can be dispensed with, which saves storage space and costs.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective view of a truck according to the invention; and

FIG. 2 shows a driver's cab with vehicle-mounted, extendable supports.

### DETAILED DESCRIPTION OF THE DRAWINGS

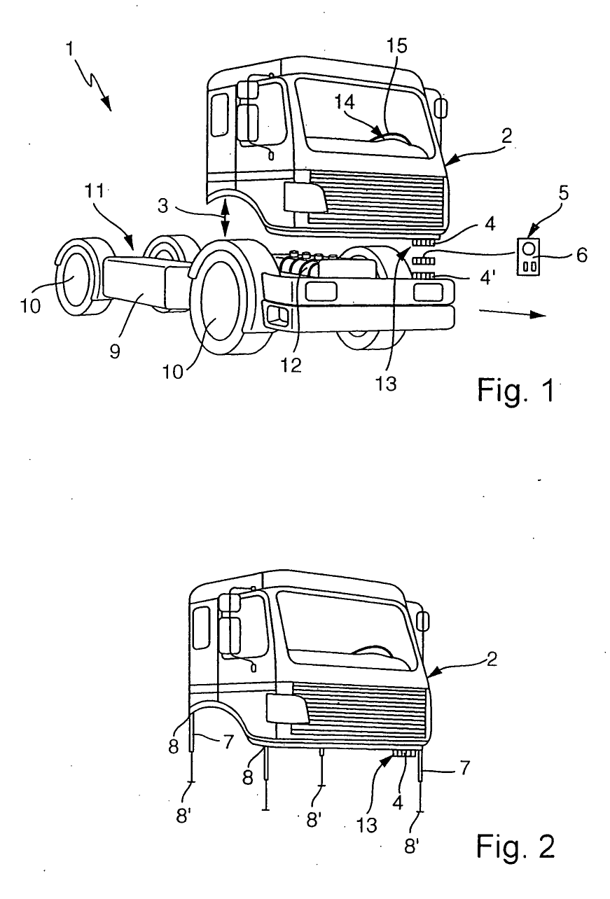

According to FIG. 1, a truck 1 according to the invention has a vehicle chassis 11 comprising a frame 9 and axles 10, and also a driver's cab 2 fastened detachably to the vehicle chassis 11. The driver's cab 2 comprises equipment components (not shown individually), such as for example seats, dashboard, sleeping location etc., and also operating elements 14, such as for example pedals, operating switches, steering wheel etc. It is surrounded by a cab housing with front wall and rear wall and also side walls with doors and a roof and also a cab floor. The operating elements 14, such as a steering handle 15, are connected to associated components of the vehicle chassis 11 (in this case to a steering device, not described further) and serve to operate them. Further operating elements 14 and associated components on the vehicle chassis 11 may for example comprise the pairs (not shown), from the following group: brake pedal and brake devices, accelerator pedal and drive device 12, electric switches and lighting device, electric switches and hydraulic systems, for example for a tipping loader etc. In this connection, the driver's cab 2 is designed as a unit which is removable essentially in the raising direction 3.

An interface arrangement 13, via which all the operating elements 14 of the driver's cab 2 are connected separably to the respective associated components of the vehicle chassis 11, is provided between the vehicle chassis 11 and the driver's cab 2. In FIG. 1, for the sake of clarity, only a single interface is drawn for the interface arrangement 13, but it is clear that the interface arrangement 13 can comprise a number of interfaces between the driver's cab 2 and the vehicle chassis 11. The interface arrangement 13 or its interfaces is or are advantageously designed in the form of at least one plug-type connection 4, 4′, one part 4 which is arranged on the driver's cab 2, with the other part 4′ of being arranged on the vehicle chassis 11. The plug-type connection 4, 4′ may be of standardized design, so that different driver's cabs 2 can be combined with different vehicle chassis 11, and may comprise quick coupling means, such as for example clip-type locking device.

According to FIG. 1, the driver's cab 2 can be removed from the vehicle chassis 11 in the raising direction 3, so that the drive device 12 originally concealed by the driver's cab 2 becomes accessible. When the driver's cab 2 has been removed, an external operating device 5, (preferably a remote control 6) can be connected to the part 4′ of the plug-type connection on the chassis. In this manner, at least one component of the vehicle chassis 11, for example the drive device 12, the brake device and/or the steering device, can be operated, so that the vehicle chassis 11 is mobile to a certain extent even without the driver's cab 2 mounted. It is now possible to give all the control commands, such as for example accelerator, brake, light etc., which are normally sent from the operating elements 14 arranged in the driver's cab 2, via the external remote control 6 and thus for example to control the drive device 12.

The driver's cab 2 is connected to the vehicle chassis 11 at suspension points 8 or 8′, and the connection can be designed in particular as a screwed connection. According to a first variant, the suspension points 8 are arranged at a lower end of the driver's cab 2, or at an upper end of extendable supports 7, whereas, in a second variant, the suspension points 8′ are arranged at a lower end of the extendable supports 7.

The extendable supports 7 serve to raise the driver's cab 2 in the raising direction 3 and are either mobile or vehicle-mounted. The suspension points 8 serve as the point of application for mobile supports 7, whereas the suspension points 8′ are intended for vehicle-mounted supports. In a vehicle-mounted design of the supports 7, these can preferably be integrated into the driver's cab 2.

The functioning of the invention is to be explained briefly in greater detail below.

For maintenance that requires the driver's cab 2 to be completely removed, the connections between the driver's cab 2 and the vehicle chassis 11 are undone first according to a first variant. The plug-type connection 4 at the interface arrangement 13 between the driver's cab 2 and the vehicle chassis 11 is then undone, so that there are no longer any mechanical connections between the driver's cab 2 and the vehicle chassis 11. An external operating element 5 or a remote control 6 can then be connected to the interface arrangement 13. Thereafter, the mobile and/or vehicle-mounted supports 7 are applied similarly to a jack at the suspension points 8, 8′, and the driver's cab 2 is raised so far by means of these that the vehicle chassis 11 can be driven away (alternatively pulled away as well in the event of a defective drive device 12) below the driver's cab 2 by means of the remote control 6. This improves in particular the maintainability of the trucks 1, handling in the workshop and also the autonomous operation of the truck 1 without a driver's cab 2.

According to another variant, however, after the connection between the driver's cab 2 and the vehicle chassis 11 has been undone, the mobile and/or vehicle-mounted supports 7 are used to raise the driver's cab 2 first. Only then, if necessary, are the plug-type connection 4 at the interface arrangement 13.

To sum up, in the truck design according to the invention, the interface arrangement 13, by which all the operating elements 14 of the driver's cab 2 are connected separably to the associated components of the vehicle chassis 11, is provided between the driver's cab 2 and the vehicle chassis 11. The interface arrangement 13 is formed by the plug-type connection 4, to which an external remote control 6 can be connected, by means of which the vehicle chassis 11 or at least individual components thereof can be controlled.

Furthermore, mobile and/or vehicle-mounted, extendable supports 7 are provided, by means of which the driver's cab 2 can be raised.

For maintenance work, the screwed connections are undone first, and then the plug-type connection 4 at the interface arrangement 13 between the driver's cab 2 and the vehicle chassis 11 is undone. The remote control 6 can be connected to the interface arrangement 13. Thereafter, the driver's cab 2 is raised so far with the aid of the supports 7 that the vehicle chassis 11 can be driven away below the driver's cab 2.

Alternatively, after the connections between the driver's cab 2 and the vehicle chassis 11 have been undone, the driver's cab 2 can be raised first and only then, if necessary, the plug-type connection 4 at the interface arrangement 13 can be undone/the remote control 6 can be connected.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. A truck comprising:
a vehicle chassis including a frame and axles;and
a driver's cab mounted on the vehicle chassis, which cab comprises equipment components, a cab floor and also a cab housing and operating elements; wherein,
the operating elements are connected to associated components of the vehicle chassis and serve to operate them;
the driver's cab is fastened detachably to the vehicle chassis and designed as a removable unit;
an interface arrangement is provided, by which all the operating elements of the driver's cab are connected separably to the associated components of the vehicle chassis; and
the vehicle chassis is controllable by an external operating device when the driver's cab has been removed.

13. The truck as claimed in claim 12, wherein the interface arrangement is formed by at least one plug-type connection.

14. The truck as claimed in claim 13, wherein the at least one plug-type connection is of standardized design.

15. The truck as claimed in claim 14, wherein the at least one plug-type connection is formed by quick coupling means.

16. The truck as claimed in claim 15, wherein the external operating device comprises a remote control.

17. The truck as claimed in claim 16, wherein the external operating device is connected to at least one component of the vehicle chassis (11) via the interface arrangement.

18. The truck as claimed in claim 17, wherein the driver's cab comprises suspension points, which are connectable to the vehicle chassis.

19. The truck as claimed in claim 18, wherein the suspension points are screwable to the vehicle chassis.

20. The truck as claimed in claim 19, further comprising mobile or vehicle-mounted, extendable supports, by which the driver's cab can be raised.

21. The truck as claimed in claim 20, wherein the vehicle-mounted supports are integrated into the driver's cab.

22. The truck as claimed in claim 21, wherein the suspension points are designed on the supports.

23. The truck as claimed in claim 22, wherein the operating elements and the associated components comprise at least one pair selected from the group consisting of: steering handle and steering device, brake pedal and brake device, accelerator pedal and drive device, electric switch and lighting device, electric switch and hydraulic system.
